(19) United States
(12) Patent Application Publication
(10) Pub. No.: US 2007/0149197 A1
(43) Pub. Date: Jun. 28, 2007

(54) Method and apparatus for managing association of base station

(75) Inventors: Seung-Que Lee, Daejeon-city (KR); June-Bae Seo, Gunpo-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/635,474

(22) Filed: Dec. 7, 2006

(30) Foreign Application Priority Data
Dec. 9, 2005 (KR) 10-2005-0120823

(51) Int. Cl. H04Q 7/20

(52) U.S. Cl. 455/436; 455/525

(57) ABSTRACT

In order for a mobile station to manage association of a base station, it is determined whether the base station satisfies Carrier to Interference Noise Ratio (CINR) condition of the mobile station. In addition, a moving probability value of the mobile station into a base station that satisfies the condition is compared with a reference threshold value, and the base station is managed as one of an active set and a semi-active set. Herein, the moving probability value indicates a probability, which is obtained based on a previous moving path of the mobile station into the base station.

### PRIORITY

This application claims the benefit under 35 U.S.C. §119 to an application filed in the Korean Intellectual Property Office on Dec. 9, 2005, and assigned Serial No. 10-2005-0120823, the contents of which are incorporated herein by reference.

### BACKGROUND OF THE INVENTION

1. Field of the Invention

The present invention relates generally to a Base Station (BS) association method of a Mobile Station (MS) and an apparatus using the same, and in particular, it relates to an active set managing method in a portable Internet system.

2. Description of the Related Art

A portable Internet system uses an Orthogonal Frequency Division Multiplexing (OFDM) scheme for modulation and demodulation, and a Frequency Division Multiple Access/Time Division Multiple Access (FDMA/TDMA) scheme for user multiplexing.

Since a plurality of base stations provide services like a cellular system in the portable Internet system, a mobile station needs to perform handover to a base station into which the mobile station is moving so as to handover a control to the base station.

A Fast Base Station Switching (FBSS) method reduces a delay time during a handover in the portable Internet system. According to the FBSS method, a mobile station registers a plurality of base stations that can be used by the mobile station for communication other than a current serving base station while moving from one base station to another. Subsequently, the mobile station manages the plurality of registered base stations as an active set, and the base stations in the active set share a Medium Access Control (MAC) context of the mobile station. Herein, a MAC context indicates information that a mobile station and a base station exchange during network entry.

In addition, the mobile station can handover control from a current base station in the active set to another base station in the same active set promptly by performing by pre-reserving resources for the mobile station, that is, by performing a pre-handover process.

In this case, all base stations in the active set must use a common time source and the same frequency channel, share the MAC context, and perform synchronization of a transmission frame structure with each other In addition, the mobile station checks whether a required Quality Of Service (QoS) is satisfied when forming an active set. Therefore, when the mobile station registers the base stations in the active set, the registered base stations must be able to pre-reserve resources for the mobile station.

According to the conventional FBSS method, base stations having a high moving probability of the mobile station are controlled to perform a large portion of a handover in advance such that a handover delay time can be reduced. However, the FBSS method hands over the control to one of the base stations in the active set, and therefore, resource waste may occur due to other base stations to which the control is not given. Therefore, characteristics of managing the active set between the mobile station and the base station may become a main factor that affects system performance.

Currently, adding or removing a candidate base station depending on a received signal strength transmitted from the base station manages the active set.

However, when updating the active set based on the signal put all base stations that communicate with the mobile station as a candidate base station, and therefore, this method does not take mobility of the mobile station into account. Accordingly, when the mobile state is located in a boundary of a plurality of cells, too many base stations will be included in the active set and therefore severe resource waste may occur due to pre-handover processes performed by the base stations.

The above information disclosed in this Background section is only for enhancement of understanding of the background of the invention and therefore it may contain information that does not form the conventional art that is already known in this country to a person of ordinary skill in the art.

### SUMMARY OF THE INVENTION

The present invention has been made to provide an active set managing method having advantages of increasing system efficiency in a portable Internet system.

An preferred method according to the present invention is provided to a mobile station to manage association of a base station. The method includes selecting a base station that satisfies a signal condition; and comparing a moving probability value of the mobile station into the base station with a reference threshold value to manage association of the base station. The moving probability value indicates a probability, which is obtained based on a previous moving path of the mobile station into the base station.

Accordingly, the signal condition includes a Carrier to Interference and Noise Ratio (CINR) of the mobile station.

In addition, the selection of the base station includes extracting a handover setting value that is a parameter indicating an accessible base station from a message transmitted from the at least one base station; comparing a value of the CINR of the mobile station with the handover setting value; and determining the at least one base station as the base station that satisfies the signal condition when the value corresponding to the CINR is greater than the handover setting value.

An preferred method according to the present invention is provided to a mobile station to associate a base station. The method includes determining at least one first base station as one of an active set candidate that performs a resource reservation process included in a pre-handover process and a semi-active candidate that does not perform the resource reservation process; generating a first message for requesting active set update; transmitting the first message to a second base station for serving the mobile station; receiving a second message for accepting the active set update from the second base station; generating a third message to information that the at least one first base station is associated with one of the active set and the semi-active set; and transmitting the third message to the second base station.

A preferred apparatus according to the present invention manages association of a base station. The apparatus includes a path history managing unit, a moving probability calculation unit, and a controller.

The path history managing unit checks a current serving base station either when a base station is changed or on a periodic basis, and stores an identifier that indicates a moving path of the mobile station. The moving probability calculation unit receives the identifier from the path history managing unit and calculates a moving probability value of the mobile station into the base station based on the identifier. The controller selects a candidate base station to be associated with either an active set or a semi-active set, and manages association of the candidate base station by using the moving probability received from the moving probability calculation unit. The moving probability value indicates a probability, which is obtained based on a previous moving path of the mobile station into the base station.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a concept of an active set management method of a portable Internet system according to an exemplary embodiment of the present invention.

FIG. 2 is a block diagram illustrating a mobile stations according to the exemplary embodiment of the present invention.

FIG. 3 is a flowchart illustrating a process for associating a base station to one of an active set and a semi-active set by a mobile station according to the exemplary embodiment of the present invention.

FIG. 4 is a ladder diagram illustrating a transmitting/receiving signal flow between a mobile station and a base station, where the mobile station associates the base station to one of the active set and the semi-active set according to the exemplary embodiment of the present invention.

### DETAILED DESCRIPTION OF THE PREFERRED EMBODIMENTS

A preferred embodiment of the present invention will hereinafter be described in detail with reference to the accompanying drawings.

In the following detailed description, only certain preferred embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Further, herein each block means a unit that performs a specific function or operation, and can be realized by hardware or software, or a combination of both.

An active set managing method in a portable Internet system according to the present invention will be described in greater detail with reference to the accompanying drawings.

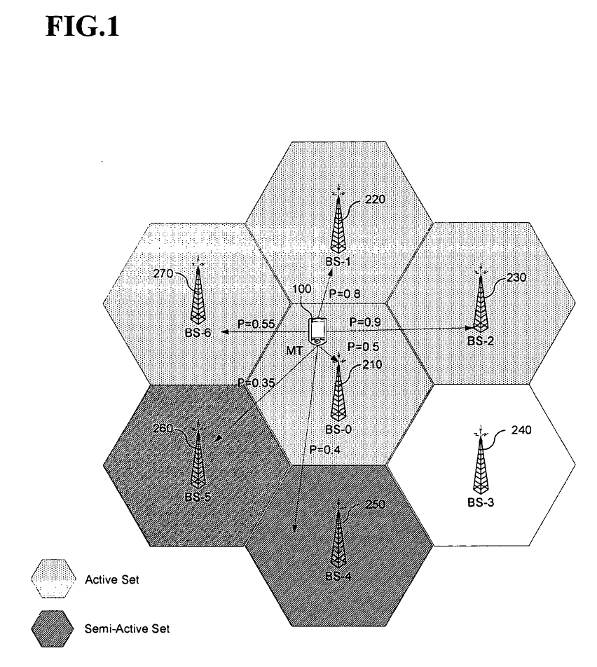

FIG. 1 diagram illustrating an active set managing method in a portable Internet system according to an exemplary embodiment of the present invention.

A mobile station 100 manages a moving path history of the mobile station 100. That is, the mobile station 100 checks a current serving base station when a base station is changed or on a periodic basis, and stores an identifier of the current serving base station. Accordingly, the mobile station 100 may check a current serving base station within a predetermined range of time.

Based on the stored identifier, moving probability values that the mobile station 100 moves to neighboring Base Stations (BS-1 to BS-6) 220, 230, 240, 250, 260, and 270, and an anchor base station (BS-0) 210 from a current location can be acquired. The mobile station 100 tends to repeatedly roam through a familiar location such as home or work and the probability of the tendency may be used as information for predicting a base station to which the mobile station will relocate.

In addition, the mobile station 100 uses a signal condition and a moving path probability when adding a base station to an active set.

According to the exemplary embodiment of the present invention, the signal condition requires a moving average value of a Carrier to Interference and Noise Ratio (CINR) to be greater than a handover setting value. The predetermined handover value is a threshold value indicating an accessible base station when handover occurs and may be provided as H_Add Threshold included in a Downlink Channel Descriptor (DCD) according to the Institute of Electrical and Electronics Engineers (IEEE) standard 802.16e.

The mobile station 100 selects a candidate base station to be added to an active set according to the signal condition, and re-examines the candidate base station by using a moving probability value. The moving probability value is calculated by using a conventional method, and therefore, a further description will be omitted.

It is assumed in FIG. 1 that candidate base stations satisfying the signal condition include BS-0 210, BS-1 220, BS-2 230, BS-4 250, BS-5 260, and BS-6 270. As shown in FIG. 1, moving probability values of the mobile station to the candidate base stations that satisfy the signal condition are shown in Table 1 below.

TABLE 1

| | |
|---|---|
| Terminal −> BS-0 | P = 0.5 |
| Terminal −> BS-1 | P = 0.8 |
| Terminal −> BS-2 | P = 0.9 |
| terminal −> BS-4 | P = 0.4 |
| terminal −> BS-5 | P = 0.35 |
| terminal −> BS-6 | P = 0.55 |

The mobile station 100 compares a reference threshold value (assume, 0.5) predetermined by the system with the moving probability values (Ps) of the mobile station 100 with respect to the candidate base stations that satisfy the signal condition.

The mobile station 100 classifies the candidate base stations BS-0 210, BS-1 220, BS-2 230, and BS-6 270 having the moving probability value P greater than a reference threshold value are classified into a first group, and the target base stations (BS-4 250 and BS-5 260) having the moving probability value P less than the reference threshold value are classified into a second group. The first group is set to an active set and the second group is set to semi-active set.

As described, the base stations are classified into the active set and the semi-active set for operation, and this classification may differentiate a pre-handover level. According to another exemplary embodiment of the present invention, the base station in the semi-active set may not perform a bandwidth resource reservation process included in the pre-handover process, which is performed by base stations in the active set. Therefore, the semi-active set can prevent unnecessary bandwidth resource reservation of base stations that have low moving probability.

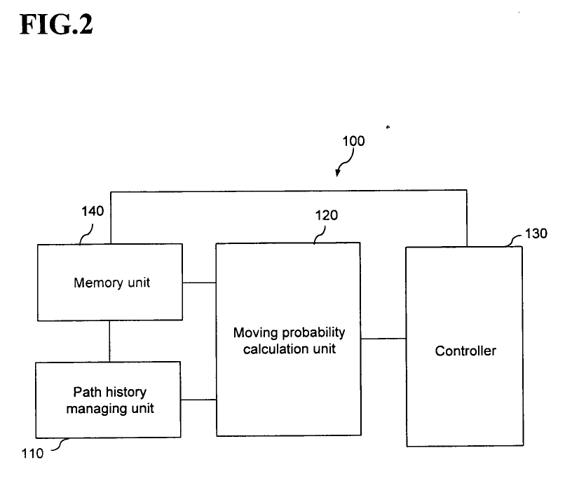

The mobile station 100 according to the exemplary embodiment of the present invention will now be described in greater detail with reference to FIG. 2. FIG. 2 is a block diagram illustrating the mobile station 100 according to the exemplary embodiment of the present invention.

The mobile station 100 includes a path history managing unit 110, a moving probability calculation unit 120, a controller 130, and a memory unit 140.

The path history managing unit 110 checks a current serving base station whenever a base station is changed or on a periodic basis, and stores an identifier of the current serving base station.

The moving probability calculation unit 120 receives the identifier from the path history managing unit 110 and calculates moving probability values of the mobile station 100 in a current location to the neighboring base stations 220 to 270 and the anchor base station 210.

The controller 130 selects a candidate base station to be added to the active set according to a signal condition. That is, the controller 130 adds the target base station to the active set group when a CINR is greater than a handover setting value.

After selecting the candidate base station to be added to the active set group, the controller 130 determines to which group among the active set group and the semi-active set group the selected candidate base station is classified by using the moving probability values received from the moving probability calculation unit 120.

That is, the controller 130 includes the candidate base station in the active set group when the moving probability value of the mobile station 100 is greater than a predetermined threshold value set by the system, and includes the candidate base station to the semi-active set group when the moving probability value of the mobile station 100 is less than the predetermined threshold value.

The memory unit 140 temporally stores data processed by the controller 130, or temporally stores the moving probability value calculated by the moving probability calculation unit 120 and the identifier output from the path history managing unit 110.

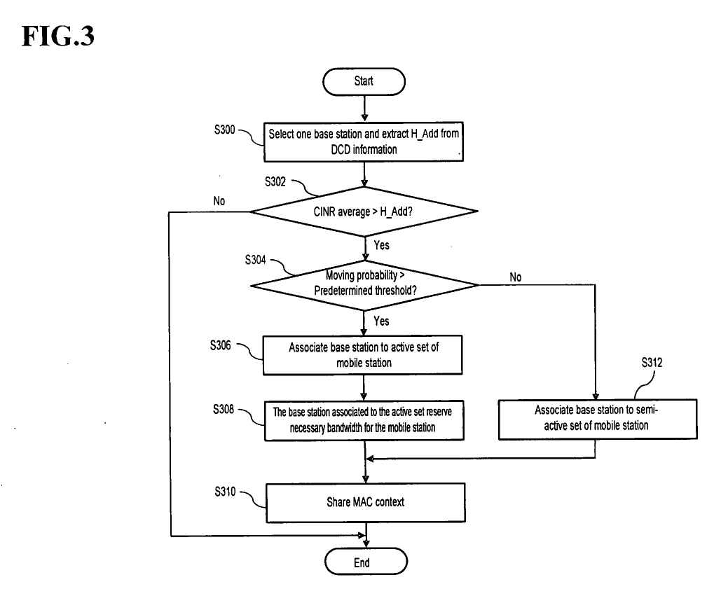

A method for the mobile station 100 to associate a base station to the active set or the semi-active set will be described with reference to FIG. 3.

FIG. 3 is a flowchart of a method for the mobile station 100 to associate a base station to the active set or the semi-active set according to the exemplary embodiment of the present invention.

The controller 130 of the mobile station 100 selects a base station among neighboring base stations, and extracts a handover setting value from a Downlink Channel Descriptor (DCD) transmitted from the base station, in step S300.

Subsequently, in step S320 the controller 130 of the mobile station 100 determines whether an average of CINRs is greater than the handover setting value.

Upon determining in S302 that the average of the CINRs is greater than the handover setting value, the controller 130 of the mobile station 100 compares the moving probability value stored in the mobile station 100 and the threshold value predetermined by the system, in step S304. Upon determining in step S304 that the moving probability value of the mobile station into the selected base station is greater than the threshold value, in step S306 the controller 130 of the mobile station 100 associates the selected base station to the active set.

The base station associated with the active set reserves a bandwidth required for the mobile station 100 and receives a Medium Access Control (MAC) context from another base station arid shares the context, in steps S308 and S310.

Herein, the MAC context includes all information that a mobile station and a base station normally exchange during Network entry. That is, the mobile station 100 automatically performs the same registration or authorization on other base stations in the active set as it performed on the anchor base station.

In addition, the base stations in the active set share mapping between service flows and connections in the mobile station 100, and an authorization key as well as an encryption key for the connection.

When it is determined in step S304 that the moving probability value of the mobile station 100 into the selected base station is less than the reference threshold value, the controller 130 of the mobile station 100 associates the selected base station with the semi-active set, in step S312.

Subsequently, in step S310 the base station associated with the semi-active set receives a MAC context from another base station in the semi-active set and shares the context.

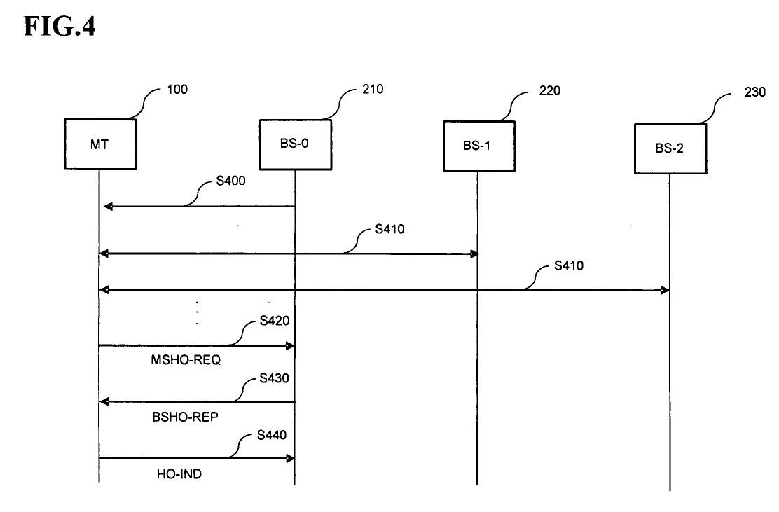

A method for the mobile station 100 to associate a base station to the active set or the semi-active set will be described with reference to FIG. 4. In this case, the mobile station 100 is being served from another base station. FIG. 4 shows a transmitting/receiving signal flow between the mobile station 100 and a base station when the mobile station 100 associates the base station to the active set or semi-active set according to the exemplary embodiment of the present invention.

Assume that a serving base station of the mobile station 100 is BS-0 210, and neighboring base stations of the serving base station 210 are BS-1 220 and BS-2 230.

The mobile station 100 receives a BeighBor-ADvertisement (NBR_AD) message from the serving base station 210 to detect the neighboring base stations 220 and 230, in step S400.

The mobile station 100 detects the neighboring base stations 220 and 230 through the NBR_AD message and synchronizes with the neighboring base stations 220 and 230, in step S410.

After the synchronization, the mobile station 100 determines whether to associate a base station or determines a candidate base station by using the base station association process of FIG. 3. In this case, assume that the base station 220 is a semi-active set candidate base station and the base station 230 is an active set candidate base station.

Subsequently, the mobile station 100 includes information on the base station 230 determined to the active set candidate base station to a candidate active set parameter included in a Mobile Station HandOver-REQuest (MSHO-REQ) message, and includes information on the base station 220 determined to the semi-active candidate base station to a candidate semi-active set parameter included in the MSHO_REQ message, and transmits the MSHO-REQ message to the serving base station 210, in step 420.

The serving base station 210 transmits a Base Station Handover-Response (BSHO_RES) message that includes a parameter (Active BS Set={BS-0, BS-2}) for the active set candidate base stations and a parameter (Semi-Active BS Set={BS-1}) for the semi-active set candidate base station to the mobile station 100, in step S430 responding to the MSHO_REQ message.

When receiving the BSHO-RSP message, the mobile station 100 generates a HandOver-INDication (HO-IND) message and transmits the HO-IND message to the serving base station 210. Accordingly, in step S440 the base station 230 is associated with the active set, and the base station 220 is associated with the semi-active set. Herein, the base station 210 is the current serving base station, and therefore, it is automatically associated with the active set.

As described, according to another aspect of the present invention, base stations with a high moving probability are grouped into the active set and base station with a low moving probability are grouped into the semi-active set by utilizing the signal condition and statistical information on characteristics of the mobility of the mobile station such that unnecessary resource waste can be prevented, thereby improving system performance.

The above-described aspects of the present invention may be realized by an apparatus and a method, but may also be realized by a program that realizes functions corresponding to configurations of the present invention or a recording medium that records the program. A person skilled in the art can easily perform such a realization.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a mobile station to manage association of a base station, the method comprising:
selecting a base station that satisfies a signal condition; and
comparing a moving probability value of the mobile station into the base station with a reference threshold value to manage association of the base station.

2. The method of claim 1, wherein the moving probability value indicates a probability, which is obtained based on a previous moving path of the mobile station into the base station.

3. The method of claim 1, wherein the signal condition includes a Carrier to Interference and Noise Ratio (CINR) of the mobile station.

4. The method of claim 3, wherein the selection of the base station comprises:
extracting a handover setting value that is a parameter indicating an accessible base station from a message transmitted from at least one base station;
comparing a value of the CINR of the mobile station with the handover setting value; and
determining the at least one base station as the base station that satisfies the signal condition when the value corresponding to the CINR is greater than the handover setting value.

5. The method of claim 4, wherein the message corresponds to a Downlink Channel Descriptor (DCD), and the handover setting value corresponds to an H_Add Threshold based on the Institute of Electrical and Electronics Engineers (IEEE) standard 802.16e.

6. The method of claim 1, wherein managing the association of the base station comprises associating the base station with one of an active set and a semi-active set according to a result of the comparison between the moving probability value and the reference threshold value.

7. The method of claim 1, wherein a base station associated with the semi-active set does not perform a bandwidth resource reservation process included with a pre-handover process performed by a base station associated in an active set.

8. The method of claim 1, wherein managing the association of the base station comprises:
associating the base station with an active set of the mobile station when the moving probability value is greater than the reference threshold value;
receiving bandwidth information on bandwidth resource reservation for the mobile station from the base station; and
receiving and sharing Medium Access Control (MAC) context from another base station.

9. The method of claim 1, wherein managing the association of the base station comprises:
associating the base station with a semi-active set of the mobile station when the moving probability value is less than the reference threshold value; and
receiving and sharing a MAC context from another base station.

10. A method for a mobile station to associate a base station, the method comprising:
determining at least one first base station as one of an active set candidate that performs a resource reservation process included in a pre-handover process and a semi-active candidate that does not perform the resource reservation process;
generating a first message for requesting active set update;
transmitting the first message to a second base station for serving the mobile station;
receiving a second message for accepting the active set update from the second base station;
generating a third message to inform that the at least one first base station is associated with one of the active set and the semi-active set; and
transmitting the third message to the second base station.

11. The method of claim 10, further comprising:
receiving a fourth message for detecting the at least one first base station from the second base station; and
synchronizing with the at least one first base station.

12. The method of claim 10, wherein the determining step comprises:
extracting a handover setting value that is a parameter indicating an accessible base station from a fifth message transmitted from the at least one first base station;
comparing a value corresponding to a Carrier to Interference Noise Ratio (CINR) of the mobile station with the handover setting-value;
comparing a moving probability value of the mobile station into the at least one first base station with a reference threshold value when the value corresponding to the CINR is greater than the handover setting value, and
determining the at least one first base station to one of the active set candidate and the semi-active set candidate according to a result of the comparison.

13. The method of claim 10, wherein the moving probability value indicates a probability which is obtained based on a previous moving path of the mobile station into the at least one first base station

14. The method of claim 10, wherein, when the at least one first base station is associated with the semi-active set, the at least one first base station does not reserve a bandwidth resource necessary for the mobile station, and receives and shares a medium access control (MAC) context from another base station.

15. The method of claim 10, wherein the first message includes information on a base station for the active set and information on a base station for the semi-active set, and
the second message includes information on a base station determined to the active set and information on a base station determined to the semi-active set.

16. An apparatus for managing association of a base station, the apparatus comprising:
a path history managing unit for checking a current serving base station when a base station is changed or on a periodic basis, and storing an identifier that indicates a moving path of the mobile station;
a moving probability calculation unit for calculating a moving probability value of the mobile station into the base station based on the identifier; and
a controller for selecting a candidate base station to be associated with either an active set or a semi-active set, and managing association of the candidate base station by using the moving probability.

17. The apparatus of claim 16, wherein the moving probability value indicates a probability, which is obtained based on a previous moving path of the mobile station into the base station.

18. The apparatus of claim 16, wherein the controller selects a base station that satisfies a given condition as the candidate base station,
wherein the given condition is that a Carrier to Interference and Noise Ratio (CINR) is greater than a handover setting value that is a parameter indicating an accessible base station.

19. The apparatus of claim 16, wherein the controller compares the moving probability value with a reference threshold value to associate the candidate base station with one of the active set and a semi-active set.
